(19) United States
(12) Patent Application Publication
(10) Pub. No.: US 2009/0214355 A1
(43) Pub. Date: Aug. 27, 2009

(54) FIXING METHOD FOR A TIP WINGLET AND REDUCED TIP LEAKAGE BLADE

(76) Inventors: Michele Pereti, Baden (CH); Joergen Ferber, Wutoeschingen (DE)

Correspondence Address: CERMAK KENEALY VAIDYA & NAKAJIMA LLP, 515 E. BRADDOCK RD, ALEXANDRIA, VA, 22314, US

(21) Appl. No.: 12/390,538

(22) Filed: Feb. 23, 2009

(30) Foreign Application Priority Data
Feb. 25, 2008 (EP) 08101944.0

(51) Int. Cl. F01D 5/18; B23P 6/00

(52) U.S. Cl. 416/97 R; 29/889.1

(57) ABSTRACT

Reducing the tip leakage for an existing compressor or turbine blade (10), including internally cooled blades, can be achieved by retrofitted the blade with a tip leakage-reducing device in the form of a winglet (12). The winglet (12) can be fixed onto the tip portion by bonding the winglet onto the face or faces of the blade by a key and slot arrangement.

This application claims priority under 35 U.S.C. §119 to European application no. 08101944.0, filed 25 Feb. 2008, the entirety of which is incorporated by reference herein.

### BACKGROUND

1. Field of Endeavor

The invention relates to turbine and compressor blades, more specifically to an apparatus and method for reducing the tip leakage of such blades.

2. Brief Description of the Related Art

Compressor and turbine blades are characterised by being subject to extreme operating conditions. These include, in the case of compressor blades, operating temperatures of typically up to 500° C. and, for turbine blades, typically above 500° C. for last stage blades, and greater than 1000° C. for first stage blades. These high temperatures can necessitate the inclusion of internal cooling. Further, compressor/turbine blades are subject to high centrifugal loads operating typically at minimum speeds of between 3000-3600 min⁻¹. The special consideration of material selection, manufacturing technique and design required to enable operation under these environments differentiate these blades from other types of blades.

A known compressor/turbine inefficiency is gas leakage across a blade tip, commonly known as tip leakage, from the pressure side to the suction side of the blade. To overcome this problem, tip arrangements have been developed that rely on increasing flow resistance across the blade tip. A common arrangement, referred to as a winglet or mini shroud, includes ribs or brackets formed at the blade tip. An example can be found in U.S. Pat. No. 6,565,324. The problem with the application of that disclosure is the acceptance that, due to the exacting engineering requirements as a result of harsh operating environments, blade improvements must be formed during the manufacture of the blades and cannot be retrofitted. Therefore, in order to take advantage of the solutions in that patent, existing blades must be replaced at significant cost.

While it is known to modify fan blades as described in U.S. Pat. No. 7,252,478, those solutions are not applicable to compressor or turbine blades due to very different operating environments. Fan blades of the type described in U.S. Pat. No. 7,252,478 typically are subject to temperatures around 50° C and low revolution speed.

### SUMMARY

One aspect of the present invention deals with the problem of reducing the tip leakage of compressor or turbine blades that are subject to high centrifugal forces and thermal stresses. It addresses this problem by providing a method and an apparatus that attempts to overcome the apparent deficiencies of known winglet forming methods.

Another aspect of the present invention is based on the general idea of modifying existing compressor/turbine blades to retrofit tip leakage prevention designs in such as way as not to compromise the mechanical integrity of existing internal cooling arrangements.

Another aspect provides a method for modifying a turbine or compressor blade comprising a tip portion and having a tip wall, a pressure face, and a suction face. The method locates a winglet on one or each of the faces of the tip portion such that, in use, tip leakage is reduced, and includes the steps of:

A. machining one or more slots through one or each of the faces

B. manufacturing the winglet such that the winglet comprises one or more keys on an inner edge face such that the one or more keys are receivable by one or more of the slots therein;

C. engaging the inner edge face of the winglet with the one or each of the faces by inserting the one or more of the keys in the one or more slots; and

D. bonding the winglet to the one or each faces.

A further aspect provides that the blade is a turbine blade having internal cooling and that the winglet is bonded such that the internal cooling is not disrupted by arrangement of the winglet adjacent to the tip wall.

Another aspect provides a turbine or compressor blade comprising a tip portion having a pressure face, and a suction face, and a winglet with an inner edge face located on the blade such that in use blade tip leakage is reduced. An exemplary blade can be characterised by having: one or more slots through one or each of the faces; one or more keys on the inner edge face of the winglet wherein the one or more keys are receivable by one or more of the slots therein; and one or more keys received in the one or more slots therein enabling engagement of the inner edge with the tip portion face, wherein the winglet is bonded to the one or each tip portion faces.

A further aspect provides that the blade is a cooled turbine blade with internal cooling and the slots are arranged so that the winglet does not disrupt internal cooling flow of the blade by arrangement of the winglet adjacent to the tip wall.

Other aspects and advantages of the present invention will become apparent from the following description, taken in connection with the accompanying drawings, wherein, by way of illustration and example, an embodiment of the present invention is disclosed.

### BRIEF DESCRIPTION OF THE DRAWINGS

By way of example, an embodiment of the invention is described more fully hereinafter with reference to the accompanying drawings, in which:

FIG. 1 is a perspective view of a compressor or turbine blade with a retrofitted winglet according to a preferred embodiment of the invention;

FIG. 2 is a perspective view of the compressor or turbine blade showing slots according to a first preferred embodiment of the invention;

FIG. 3 is a sectional view through III-III in FIG. 1 showing a winglet fitted to the pressure side of the compressor or turbine blade; and

FIG. 4 is a sectional view through III-III in FIG. 1 showing a winglet fitted to the suction and pressure side of the compressor or turbine blade.

### DETAILED DESCRIPTION OF EXEMPLARY EMBODIMENTS

Preferred embodiments of the present invention are now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and devices are shown in block diagram form in order to facilitate describing the invention.

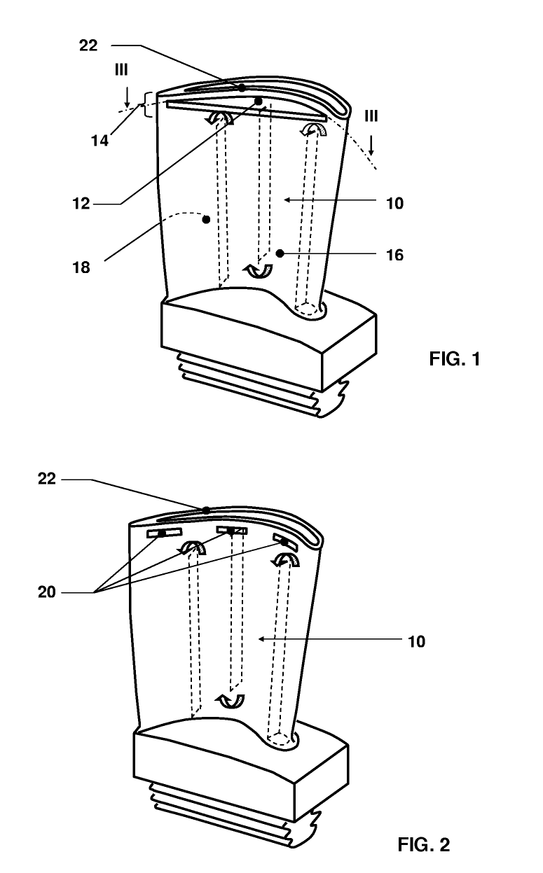

As seen in FIG. 1, disclosed is an exemplary embodiment of a manufactured compressor or turbine blade 10 that has been subsequently modified by the retrofitting of a winglet 12 on either or both of the pressure face 16 or suction face 18 of a tip portion 14. In a preferred embodiment the blade 10 is also an internally cooled turbine blade 10.

The winglet 12 is retrofitted to the compressor or turbine blade 10 in such a manner that it is capable of withstanding the extreme operating conditions it will be exposed to during operating. According to one preferred embodiment of the invention, the winglet 12 is retrofitted by being fixed to the blade 10.

An exemplary method of fixing includes machining slots 20, see FIG. 2, through either or both the pressure face 6 and suction face 18 of the tip portion 14. By providing the winglet 12 at the tip portion 14, tip leakage is minimized. The slots 20 provide a mechanism for holding the winglet 12 in place. The dimensions and number of slots 20 machined is dependent on winglet 12 design and blade 10 operating conditions. Preferably there is more than one slot 20, as in this arrangement operating stresses are more evenly distributed.

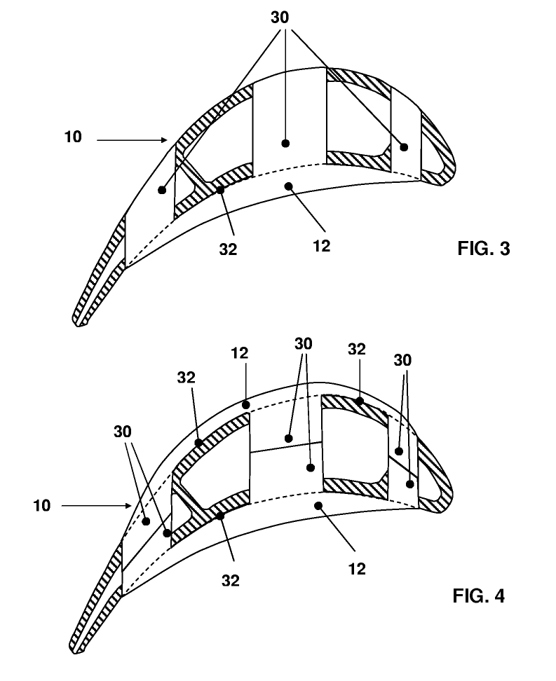

As shown in FIG. 3, a winglet 12 is manufactured to include keys 30 on an inner edge face 32, wherein the keys 30 are insertable into the slots 20 such that, after insertion, not only is the winglet 12 held in place but also the inner edge 32 of the winglet 12 engages with a face 16, 18 of the tip portion. In another preferred arrangement, FIG. 4, the winglet 12 engages the pressure face 16 and suction face 18 so as to further reduce tip leakage.

Bonding by welding the held winglet 12 to the blade tip portion 14 after insertion of the keys 30 and engagement of the winglet 12 and tip portion 14 face 16,18 then completes fixing of the winglet 12. Bonding is, however, not limited to welding but can also include brazing and other known processes.

The skilled person would also recognize that variations of the fixing method that results in the fixing of a winglet 12 with sufficient integrity to withstand the extreme operating conditions of a compressor or turbine blade 10 could be used without detracting from the intent of the invention.

As the winglet 12 is retrofitted rather than being formed as one piece with the tip, is it possible to use different materials to manufacture the tip portion 14 and winglet 12. This characteristic can be advantageously exploited, for example, to improve the oxidation or corrosion resistance of the winglet 12. Operating and design considerations could suggest other useful exploits of this characteristic.

In a further exemplary embodiment, the blade 10 is an internally cooled blade 10, and the slots are preferable arranged adjacent to the tip wall 22 so that when the winglet 12 is fixed the keys 30 of the winglet 12 do not disrupt the internal cooling flow of the blade 10 as shown in FIGS. 1 and 2.

### REFERENCE NUMBERS

10 Blade

12 Winglet

14 Blade tip portion

16 Pressure face

18 Suction face

20 Slot

22 Tip wall

25 Replacement tip portion

30 Winglet Keys

32 Winglet inner edge face

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A method for modifying a turbine or compressor blade, the blade having a tip portion with a tip wall, a pressure face, and a suction face, the method comprising:
machining at least one slot through at least one of said faces;
providing a winglet having at least one key on an inner edge face, such that said at least one key is receivable in said at least one slot;
engaging said inner edge face of said winglet with said at least one face, including inserting said at least one key in said at least one slot; and
bonding said winglet to said at least one face.

2. The method of claim 1, wherein said blade is a turbine blade having internal cooling and wherein bonding said winglet comprises bonding such that said internal cooling is not disrupted by arrangement of said winglet adjacent to said tip wall.

3. A turbine or compressor blade comprising:
a tip portion having a tip wall;
a pressure face;
a suction face;
a winglet with an inner edge face on the tip portion, configured and arranged such that in use blade tip leakage is reduced;
at least one slot through at least one of said pressure and suction faces;
at least one key on said winglet inner edge face, said at least one key being configured and arranged to be received in said at least one slot;
wherein said at least one key is received in said at least one slot with said inner edge face engaging with said tip portion; and
wherein said winglet is bonded to at least one of said faces.

4. The blade of claim 3, wherein said blade comprises a cooled turbine blade including internal cooling, and wherein said at least one slot is configured and arranged so that the winglet does not disrupt internal cooling flow of the blade by arrangement of said winglet adjacent to said tip wall.
